(19) United States
(12) Patent Application Publication
(10) Pub. No.: US 2015/0115111 A1
(43) Pub. Date: Apr. 30, 2015

(54) Hose Support Device

(71) Applicant: Tim Smith, Leo, IN (US)

(72) Inventor: Tim Smith, Leo, IN (US)

(21) Appl. No.: 14/064,242

(22) Filed: Oct. 28, 2013

(51) Int. Cl. A62C 31/28; A62C 33/00; F16L 3/02; F16M 13/02

(52) U.S. Cl. CPC A62C 31/28; F16M 13/022; A62C 33/00; F16L 3/02
USPC 248/77

(57) ABSTRACT

A hose support device is provided for connecting to a hose along its length and securing the same against a ladder while the hose is being utilized by a user thereon. The device comprises an elongated interior member having two distal end rounded members extending outward therefrom. The rounded members include an outer surface having a plurality of hose notches therein, wherein the notches of the rounded members are vertically aligned to secure to a hose in a first and second position along its length. Extending from the end of one of the rounded members is an eye bolt for suspending the device, or further for attaching a strap thereto when securing the device to a ladder. A supplementary strap is adapted to be wound around the device and a hose length positioned between two aligned notches to secure the hose therein.

### BACKGROUND OF THE INVENTION

1. Field of the Invention

The present invention relates to hose supports for use while on a ladder. More specifically, the present invention relates to a support for a length of hose that supports the hose against a ladder rail while the user controls the working end of the hose, whereby the hose length does not tangle or interfere with the user.

Pressure washing the side of a home requires a user to climb a ladder while supporting the pressure washer nozzle, which is connected to an elongated hose to the water pressure source. Most pressure washers are provided having an elongated handle and include a stiffened hose to contain the high water pressure flowing therethrough. Handling this type of device is fairly straightforward while on the ground, but while balancing on a ladder in the air, this task can become much more difficult and much more treacherous.

When spraying the side of the home, the pressure washer nozzle and hose is supported by the user as the user directs the spray of water onto the various surfaces of the home. When climbing up the ladder or handling the nozzle in different orientations, the hose of the pressure washer can easily become tangled with the user's person or with the rails of the ladder. This can cause the user to become tangled with the hose and create a risk of falling from the ladder, which is an unacceptable work hazard. Further still, the user is required to support both the pressure washer nozzle and the hose filled with water, which can quickly become heavy the higher the user climbs along the ladder.

To resolve these problems in the art, the present invention provides a hose support article that is attachable to a ladder or to a wearer, wherein a portion of the hose is supported therefrom and prevented from tangling. The device comprises an elongated interior member having two distal end rounded members extending outward therefrom. The edges of the rounded members include a plurality of notches that are adapted to secure around the circumference of a hose, whereby the notches of the first and second rounded member are aligned to support the hose in two locations along its length. The assembly further comprises an eye bolt extending from one end thereof, wherefrom a first strap is connected thereto for suspending the assembly from the rail of a ladder or the eye bolt itself may be suspended from a paint hook. Overall, the device frees the hands of a user while on a ladder, supports the hose without assistance, and prevents the hose from tangling as it is being utilized.

2. Description of the Prior Art

Devices have been disclosed in the prior art that relate to hose support articles. These include devices that have been patented and published in patent application publications, and generally relate to various clips and straps that support a hose along its length for more organized use when on a ladder. The following is a list of devices deemed most relevant to the present disclosure, which are herein described for the purposes of highlighting and differentiating the unique aspects of the present invention, and further highlighting the drawbacks existing in the prior art.

Devices have been disclosed in the art that relate to hose support articles. The majority of the art relates to hooks that attach around a circumference of the hose at a given point therealong and secure the hose to another support, such as a ladder rung or similar open support. The clips are helpful for securing a hose when on a ladder; however their structure provides only a single support location along the hose length. These devices are also prone to sliding along the hose length, which reduces the effectiveness of the support and interferes with the user operating the working end of the hose while on the ladder. The present invention relates to a new and improved hose support device that frees the hands of a user on a ladder and adequately supports the hose length therealong.

One such device indicative of the art is U.S. Pat. No. 402,900 to Campbell discloses a hose carrying strap having an upper shoulder loop strap and a first and second hook used to secure a fire hose on one end and to a fireman's shoulder on an opposing end. The first hook secures to the fire hose, while the second hook is optionally utilized to secure the hose to an upstanding ladder. The Campbell device provides a novel means of assisting a fireman while carrying a heavy fire hose up a ladder. The elements of the Campbell device, however, do not secure the hose at more than one location or prevent sliding of the hose within the attachment thereto.

Another device in the art that is U.S. Pat. No. 96,863 to Allen, which discloses a hose ladder strap that secures a fire hose to a ladder in a similar fashion as the Campbell device. The Allen device comprises a single length strap having a first end hook, a second end hook and a slide ring disposed adjacent to the second end hook. The strap is wrapped around the rung of a ladder and through the slide ring, whereafter the hooks support the fire hose from a ladder rung. Similar to the Campbell device, the Allen device fails to disclose the novel aspects of the present invention.

U.S. Pat. No. 622,246 to Matheas discloses a supporting hook for a fire hose that secures to the fire hose or fire hose nozzle using a first and second buckle strap. The buckle straps secure the hose to an outwardly extending hook having an upward shank and a downward hook shank. The hook is utilized to secure the hose to the rung of a ladder. The Matheas device, however, does not disclose the structure or the means of attachment between the present invention and a hose being supported.

Finally, U.S. Pat. No. 682,772 to Weltin discloses a hose strap and hook that comprises an elongated strap having a first hook end and a second loop end. The strap is wrapped around the circumference of a fire hose, whereafter the hook is fitted through the loop end to form a closed loop. The hook end can then be supported by the rung of a ladder, thereby supporting the fire hose therefrom. Similar to the Matheas device, the Weltin device is suitable for supporting a fire hose but fails to disclosed the means in which are provided by the present invention. Notably a device that supports a fire hose at two distinct locations and stabilizes the hose against a ladder as the working end of the hose is being manipulated by the user.

The present invention provides a new and improved structure for supporting a hose while working on a ladder. The assembly supports a hose from the ladder in two distance locations, and further allows the user to readily grasp the device to reposition the hose after initial attachment. Overall, the device improves the stability of the support and the safety with which heavy hoses are supported while working in an elevated position, which can be dangerous for the worker if the hose becomes tangled or interferes with the worker's ability to balance himself.

It is submitted that the present invention is substantially divergent in design elements from the prior art, and consequently it is clear that there is a need in the art for an improvement to existing water hose support devices. In this regard the instant invention substantially fulfills these needs.

### SUMMARY OF THE INVENTION

In view of the foregoing disadvantages inherent in the known types of hose support devices now present in the prior art, the present invention provides a new and improved device wherein the same can be utilized for providing convenience for the user when supporting a hose while on a ladder and in an elevated position.

It is therefore an object of the present invention to provide a new and improved hose support device that has all of the advantages of the prior art and none of the disadvantages.

It is another object of the present invention to provide a hose support device that supports a hose while a user is standing on a ladder or otherwise in an elevated position.

Another object of the present invention is to provide a hose support device to provide a first and second connection point along the hose length for supporting the same, while providing a secondary strap that secures the hose to the device to prevent separation while the hose is pressurized and being moved while deployed.

Yet another object of the present invention is to provide a hose support device that includes an attachment means to a larger support, wherein the device can be suspended therefrom while supporting a hose.

Another object of the present invention is to provide a hose support device that removes the need for a user to support a length of hose from a pressure washer while standing on a ladder and preventing the same from tangling with the ladder or himself.

Another object of the present invention is to provide a hose support device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the hose support device of the present invention.

FIG. 2 shows a view of the hose support device of the present invention in a working state.

FIG. 3 shows an end view of the hose support device of the present invention and the notches thereon for supporting several hoses.

FIG. 4 shows a view of the hose support device of the present invention being utilized by a user suspended on a ladder while pressure washing the side of a building.

### DETAILED DESCRIPTION OF THE INVENTION

Reference is made herein to the attached drawings. Like reference numerals are used throughout the drawings to depict like or similar elements of the hose support device. For the purposes of presenting a brief and clear description of the present invention, the preferred embodiment will be discussed as used for supporting a length of hose and preventing tangling with the user while operating a pressure washer on a ladder. The figures are intended for representative purposes only and should not be considered to be limiting in any respect.

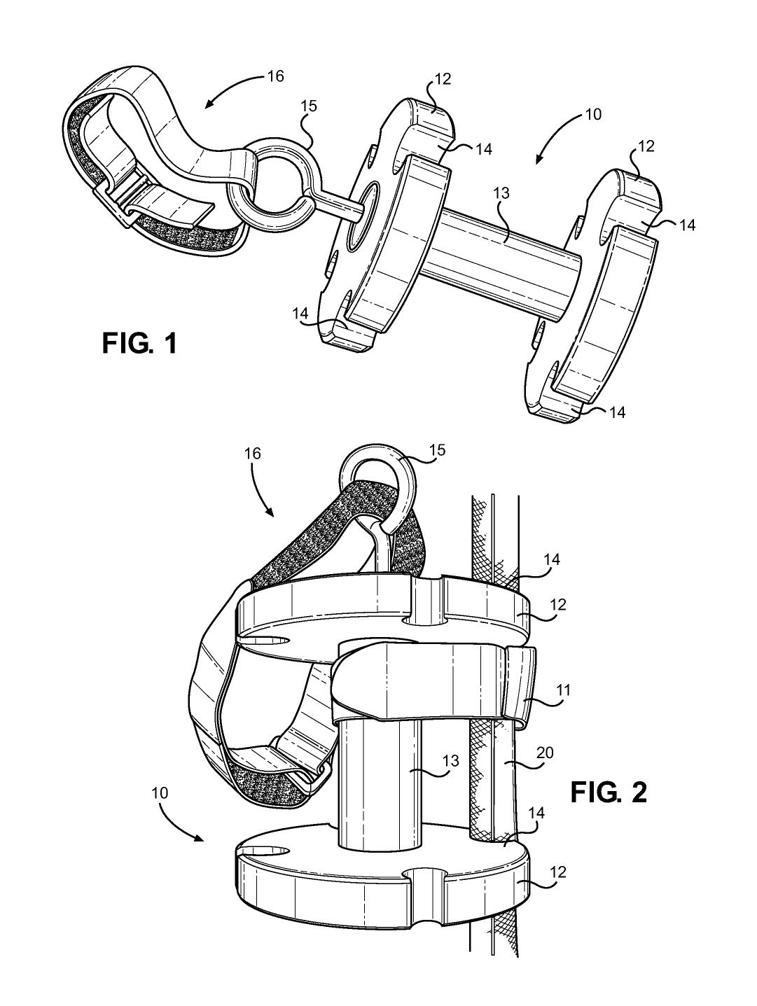

Referring now to FIG. 1, there is shown a perspective view of the hose support device 10 of the present invention. The device provides a user with a secure means of supporting a hose length from one's person or from the rung of a ladder, wherein the hose is supported at two distinct points and prevented from tangling with the ladder or interfering with the user's movement while standing on a ladder. The device comprises an elongated interior member 13 having a first and second distal end rounded members 12 extending outwardly from the interior member 13. The interior member 13 is a connector element between the two rounded members 12, while the rounded members 12 are adapted to connect to the hose along its length and support the same along the outer extent of each member 12.

Each of the rounded members 12 includes at least one, and preferably a plurality, of notches 14 along its outer perimeter. The notches 14 are rounded cutouts that are adapted to accept the outer circumference of a hose therein and secure the hose at a discrete location along the hose length. The notches 14 of the first and second rounded member 12 are concentrically aligned in a vertical orientation to allow a hose to be accepted into two complimentary notches 14 and extend between the notches in an un-kinked or straight path. The alignment of the notches aligns the interior member 13 with the hose being supported, and further provides a first and second connection point along the hose for a more stable connection therewith.

Extending from one end of the device is a secondary attachment means that allows the device to be supported by another structure, and most commonly from the rung of a ladder. The secondary attachment means comprises an eyebolt 15 and an optional support strap 16 attached thereto. The eyebolt 15 allows the device 10 to be suspended from a ladder hook or similar open-ended support, wherefrom the eyebolt 15 allows the hose support device 10 to be suspended and out of the hands of the user operating the working end of the hose. If no open-ended supports or ladder hooks are available, a strap 16 is used to secure the device to the rung or side rail of a ladder while in use, or even to a user's person. In either case, the device provides a hose support that does not require direct user interaction while handling the working end of the hose and while supporting oneself on a ladder.

Referring now to FIG. 2, there is shown a view of the hose support device 10 in a working position, supporting a hose 20 along its length and accepting the same within two of the aligned notches 14. When attaching to the hose 20, two notches 14 of the rounded members 12 are pressed against the hose 20 to force the hose 20 into the notches 14. After the hose 20 is supported within the notches 14, a supplementary strap 11 is secured around the interior member 13 and the hose 20, wherein the strap 11 is positioned between the rounded members 12 and further draws the hose 20 into the two notches 14. The strap 11 ensures the hose 20 will not separate from the notches 14 as the user is manipulating the working end of the hose 20. The strap 16 of the secondary support is fed through the eyebolt 15 and secured to the user or to the rung of the ladder. In this way, the device supports the hose along its length and eliminates any need for the user to physically handle or support the hose while operating the hose working end.

The straps 16, 11 of the present invention are elongated members having a first and second end and a strap attachment means therealong. The strap preferably includes ends with complimentary hook and loop fastening material thereon, and may further include strap adjusters or a slide adjuster. As shown in FIGS. 1 and 2, the strap includes a buckled end and a free end, wherein the free end is fed through the buckle and looped back onto itself. The free end secures along the strap length using complementary hook and loop fastening to secure the strap in a continuous loop. The loop is used to secure the hose within the notches or to secure the eyebolt to a larger support.

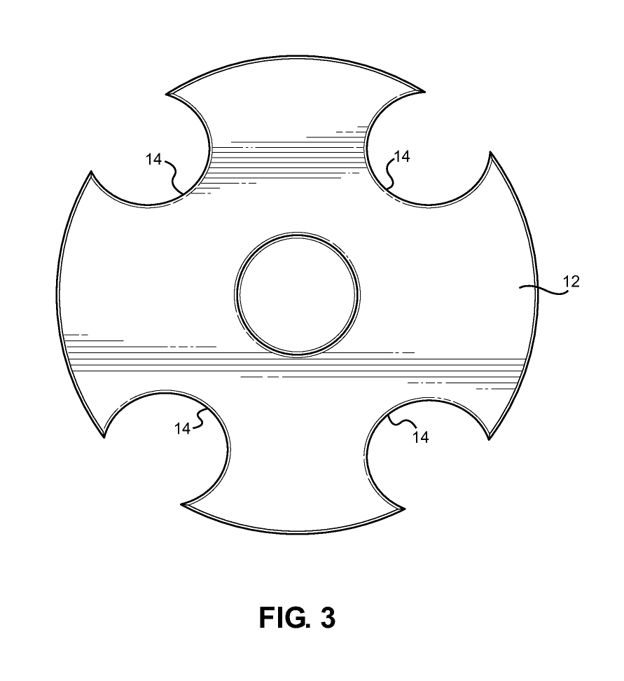

Referring now to FIG. 3, there is shown an end view of the hose support device of the present invention. In this view, the outer extent of one of the rounded members 12 is shown, along with the alignment of the notches 14. The rounded member 12 includes a plurality of notches 14 positioned along its perimeter, wherein the notches 14 are sized to accommodate the circumference of a hose positioned therein. The notches 14 of the two rounded members 12 are further concentrically aligned, as shown. The diameter of the each of the notches 14 around the members 12 may be equal, or they may be provided in different sizes to accommodate hose diameters of different dimension. The vertically aligned notches, however, share the same diameter and form a set that is adapted to support the same hose diameter across the length of the present device.

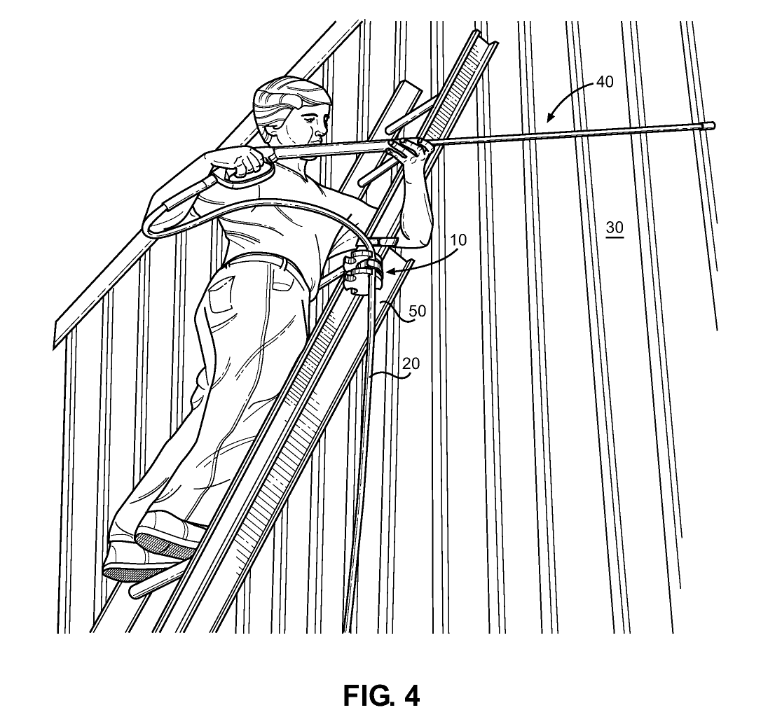

Referring now to FIG. 4, there is shown an illustration of the hose support device 10 of the present invention deployed in a working state. The device 10 supports the hose 20 of a pressure washer tool 40 while a user is standing on an extension ladder 50. The user can operate the working end of the tool 40, spraying the side 30 of a building, without being bothered with the hose length 20. The hose 20 is retained within the notches of the support device 10, which is further secured to the ladder 50 while deployed. This maintains the hose 20 along the ladder and prevents the hose 20 from tangling with the user or with the ladder 50 as the tool 40 is manipulated.

The present invention allows contractors, construction crews or homeowners who work high off the ground and maintain control over various hoses needed to complete a job. The device may is capable of supporting several hoses within the notches provided thereon, wherein the hoses may be of different sizes. This means that, for instance, the device can simultaneously support a garden hose, a pressure washer hose, a paint sprayer hose and a compressor hose. The device takes the weight off the hose while it is in use, making those who use it more productive and less distracted with the task of supporting the hose during a job.

If a user needs to remove paint from a brick house, he or she may climb a ladder with a power washer and start spraying the brick. However, sometimes the weight of the compressor hose may cause the user to become tired and the wand of the power washer may slip out of a user's hand. Likewise, hoses brought up a ladder or scaffolding by a roofer may easily become tangled or even slip off the roof. This can be dangerous for those on the ground and tiresome and time consuming for a person to have to fetch a hose every time it may fall. The present invention is contemplated as an elegant solution for the aforementioned problems, wherein the device is simple, easy to use, and inexpensive to deploy. The device supports one or more hoses that may be necessary for a tool when a user is working a job from a ladder. The device increases safety, organization, and improves efficiency with which the user can work. it is thereby submitted that the present invention advances the art of hose supports and introduces a new and useful solution not previously anticipated.

It is further submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A hose support device, comprising:
an elongated interior member having a first and second end;
a first and second rounded member extending outwardly from said first and second end of said interior member;
said first and second rounded member having a perimeter edge;
said perimeter edge further comprising at least one rounded notch therealong adapted to support the circumferences of a hose;
each notch of said first rounded member being concentrically aligned with a complimentary notch along said second rounded member;
a secondary attachment means extending from one of said rounded members.

2. The hose support device of claim 1, wherein:
said secondary attachment means further comprises an eye bolt.

3. The hose support device of claim 1, wherein:
said secondary attachment means further comprises an eye bolt and an open ended strap adapted to secure within said eye bolt and secure around another structure.

4. The hose support device of claim 1, wherein:
said each notch and said complimentary notch are of equal diameter.

5. The hose support device of claim 1, wherein:
said at least one notch in said rounded members further comprises a plurality of notches;
said plurality of notches of said rounded members having different diameters;
said each notch and said complimentary notch are of equal diameter.

6. The hose support device of claim 1, further comprising:
a supplementary strap having securable ends;
said supplementary strap adapted to secure around said interior member and a hose positioned across a pair of complimentary notches.
